(19) United States
(12) Patent Application Publication
(10) Pub. No.: US 2007/0150456 A1
(43) Pub. Date: Jun. 28, 2007

(54) SEARCH SYSTEM AND METHOD

(75) Inventors: Wen-Chuan Lian, Shenzhen, Guangdong (CN); Feng Zhou, Shenzhen, Guangdong (CN); Hua-Dong Cheng, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,026

(22) Filed: Dec. 26, 2006

(30) Foreign Application Priority Data
Dec. 27, 2005 (CN) 200510121382.4

(51) Int. Cl. G06F 17/30

(52) U.S. Cl. 707/3

(57) ABSTRACT

A search system used in an ebook reading device is provided. The system includes a search module, a relevancy calculating module, and a sort module. The search module is for searching metadata of the ebooks and comparing the metadata searched with corresponding metadata of an ebook currently displayed, thereby obtaining different comparison results based on different metadata. The relevancy calculating module is for computing relevancy values between the ebook currently displayed and the searched ebooks according to comparison results and corresponding weight values. The sort module is for sorting the searched ebooks according to the relevancy values computed, thereby obtaining different relevancy search results based on different metadata. Therefore, according to the different relevancy search results, readers can obtain different relevant information for the ebook currently displayed. A related search method is also provided.

### BACKGROUND

1. Technical Field

The present invention relates to search systems and methods, and particularly to a search system and method, used in an electronic device such as an ebook reading device.

2. General Background

Reading have traditionally been regarded as the best way for acquiring information. Reading contents are conventionally supplied on printed books. Nevertheless, printed books include quires and reams of paper, making the weight of the book substantially heavy. Furthermore, printed books are often somewhat large in size and require a definite amount of space for storing them.

Therefore, ebooks have become a good alternative for handling reading contents. Unlike printed books that are on paper, ebooks are read on an ebook reading device that displays the reading contents on a screen. A typically ebook reading device includes a storage medium that stores reading contents, a display for displaying the reading contents from the storage medium on a screen, and a display control for controlling the display. In other words, the ebook reading devices are used as printed books.

In addition, with the development of computer technologies, the storage medium now has a larger storage capacity. The ebook reading device can store a large amount of corresponding paper copied books using a large storage medium. Each of the ebooks stored is generally featured by some metadata, such as, publisher, author, work style, technical field, and so on. In general, there are some related ebooks correlated in some metadata among so many ebooks stored. For example, some ebooks may belong to a same publisher, some books may belong to a same author, some ebooks may belong to a same work style, and some ebooks may belong to a same technical field.

Therefore, when encountering an unacquainted glossary or specialized vocabulary while reading an ebook, a user can search through the storage medium to obtain related ebooks for gaining information related to the unacquainted glossary or specialized vocabulary. However, it is very troublesome and time-consuming for the user to review the related information among a large of ebooks.

What is needed, therefore, is an ebook search system and method for automatically searching related ebooks, thereby aiding the user in conveniently and easily reading ebooks.

### SUMMARY

A search system is provided. The search system is used in an ebook reading device and is for automatically searching related ebooks is provided. The search system includes a storage unit, a search module, a relevancy calculating module, a sort module, and a record module. The storage unit is for storing metadata of ebooks and a weight table, wherein the weight table records each metadata and associated weight value. The search module is for searching metadata of the ebooks in the storage unit and comparing metadata searched with the metadata of an ebook currently displayed. The relevancy calculating module is for computing relevancy values between the ebook currently displayed and the searched ebooks according to comparison results provided by the search module and the weight values provided by the storage unit. The sort module is for sorting the searched ebooks according to relevancy values computed by the relevancy calculating module. The record module is for recording the relevancy values computed by the relevancy calculating module and relevancy search results generated by the sort module.

A search method used in an ebook reading device is also provided, wherein the ebook reading device has a storage unit for storing metadata of ebooks and a weight table, the weight table recording each metadata and associated weight value. The method includes the steps of: (a) searching metadata of the ebooks in the storage unit and comparing the metadata searched with metadata of an ebook currently displayed; (b) computing relevancy values between the ebook currently displayed and the searched ebooks according to comparison results and the weight values; (c) sorting the searched ebooks according to relevancy values computed; and (d) recording the relevancy values computed and relevancy search results.

Other advantages and novel features will be drawn from the following detailed description with reference to the attached drawing, in which:

### BRIEF DESCRIPTION OF THE DRAWINGS

FIG. 1 is a schematic diagram of main function modules of a search system used in an ebook reading device in accordance with a preferred embodiment of the present invention; and

FIG. 2 is a flowchart of a preferred method for automatically searching related ebooks by utilizing the search system of FIG. 1.

### DETAILED DESCRIPTION OF THE EMBODIMENT

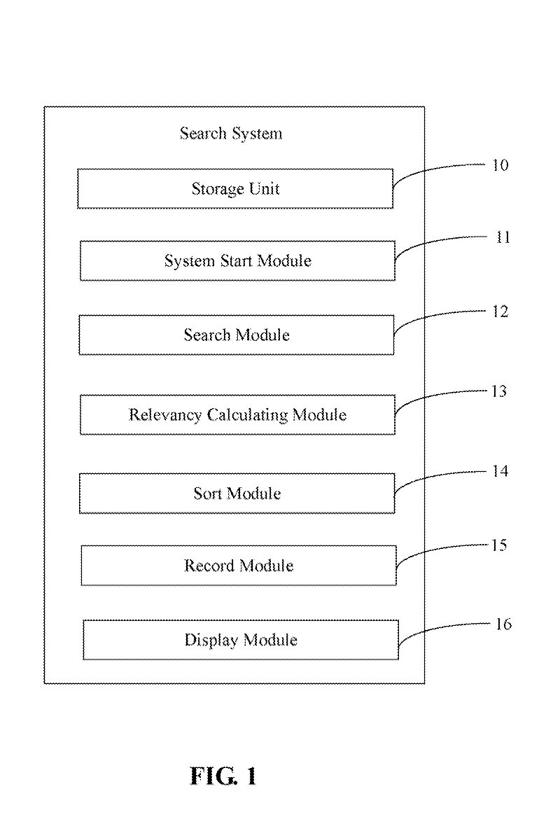

FIG. 1 is a schematic diagram of main function modules of a search system for automatically searching related ebooks in an ebook reading device in accordance with a preferred embodiment of the present invention.

Just like printed books, electronic books (ebooks) used in ebook reading devices contain bibliographic data such as author, title, subject, publisher, keywords, book summary, etc. A table of contents of the ebook, listing chapter titles, section titles, chapter extracts, and so on, can also be used as bibliographic data of the ebook. Chapter keywords in the chapter title, section keywords in the section title, and summary keywords in the book summary describing contents of the ebook can be used as bibliographic data.

These bibliographic data can be stored in metadata of each of the ebooks correspondingly, and used as relevancy parameters for computing relevancy values of each of the ebooks stored in the ebook device to a displayed ebook that is displayed by the ebook device. For simplicity, in this case, only a subject metadata, an abstract metadata, a chapter title metadata, and a section title metadata containing subject keywords, abstract keywords, chapter title keywords, and chapter section keywords of the ebook respectively are designated as relevancy parameters. However, it should be noted that the relevancy parameters may use other metadata and/or properties of the ebook such as publisher metadata, author metadata, and so on. Keywords may be publishers and authors correspondingly.

The search system includes a storage unit 10, a system start module 11, a search module 12, a relevancy calculating module 13, a sort module 14, a record module 15, and a display module 16. The storage unit 10 is for storing metadata of each of the ebooks stored in the ebook device such as, the subject metadata, abstract metadata, chapter title metadata, and section title metadata. Furthermore, the storage unit 10 stores a weight table for listing each metadata with a weight value. The weight value, (a.k.a. an evaluation coefficient), is used for indicating an evaluation significance of the metadata correspondingly. For example, the subject metadata is designated a 30% weight value, the abstract metadata is designated a 40% weight value, the chapter title metadata is designated a 15% weight value, and the section title metadata is designated a 15% weight value.

The system start module 11 is for invoking the search system if the system start module 11 detects the ebook reading device is in an ebook display state, that is , a work-rate of a processing unit (not shown) of the ebook reading device reaches a predetermined value. Furthermore, the system start module 11 disables (namely, halts/pauses) the search system if the system start module 11 detects an operational input.

The search module 12 is for searching the metadata of each of the ebooks stored in the storage unit 10 for the metadata of the displayed ebooks correspondingly. In brief, a searched ebook is selected by the search module 12, and the metadata of the searched ebook is compared with the metadata of the displayed ebook, this procedure is done until each of the ebooks has been searched. In addition, the search module 12 may use/implement different algorithms when searching and comparing the metadata.

In a first algorithm, the search module 12 compares the keywords in each of the metadata of the displayed ebook to keywords of the metadata of the searched ebook correspondingly, thus obtaining a subject comparison result, an abstract keyword comparison result, a chapter keyword comparison result, and a section keyword comparison result.

Alternatively, in a second algorithm, the search module 12 compares the keywords in each of the metadata of the displayed ebook to a metadata collection (e.g., a combination of the subject metadata, abstract keyword metadata, chapter keyword metadata, and section keyword metadata) of the searched ebook, to obtain the subject comparison result, abstract keyword comparison result, chapter keyword comparison result, and section keyword comparison result correspondingly.

The comparison result also contains a count of matches found. That is, the comparison result is dependent on the count of matches found between the keywords of the metadata (e.g., abstract, chapter, and section) of the searched ebook and the keywords of the corresponding metadata of the displayed ebook.

For example, if there are three abstract keywords of the searched ebook identical with the abstract keywords of the displayed ebook, namely, the count of matches found between the keywords of the abstract metadata of the searched ebook and the keywords of the corresponding metadata of the displayed ebook is ‘3’, accordingly, the abstract keyword comparison result is ‘3’.

If there are no identical abstract keywords between the searched ebook and the displayed ebook, namely, the count of matches found between the keywords of the abstract metadata of the searched ebook and the keywords of the abstract keywords of the corresponding metadata of the displayed ebook is ‘0’, accordingly, the abstract keyword comparison result is ‘0’.

The relevancy calculating module 13 is for computing relevancy values of the searched ebook to the displayed ebook according to the comparison results and the associated weight values.

The relevancy calculating module 13 computes an abstract relevancy value of the searched ebook to the displayed ebook according to a formula: abstract relevancy value=subject comparison result*subject weight value+abstract keyword comparison result* abstract keyword weight value.

The relevancy calculating module 13 further selects a chapter of the displayed ebook, and computes a chapter relevancy value of each chapter of the searched ebook to the selected chapter of the displayed ebook according to a formula: chapter relevancy value=chapter keyword comparison result*chapter keyword weight value. After computation, the relevancy calculating module 13 selects the chapter that has a highest chapter relevancy value among the chapters of the searched ebook as a relevant chapter to the selected chapter of the displayed ebook. These above steps are repeated until each of the chapters of the displayed ebook has been selected and an associated chapter relevancy value has been computed. In addition, readers often focus on the ebooks that have relatively high relevancy values (e.g., abstract relevancy values), therefore, under this case, the relevancy calculating module 13 only selects the searched ebook whose abstract relevancy value is greater than a predetermined value to further compute the chapter relevancy values for the displayed ebook.

The relevancy calculating module 13 also further selects a section of the selected chapter of the displayed ebook, and computes a section relevancy value of each section of the relevant chapter of the searched ebook to the section of the selected chapter of the displayed ebook according to a formula: section relevancy value=section keyword comparison result*section keyword weight value. After computation, the relevancy calculating module 13 also selects the section that has a highest section relevancy value among the sections of the relevant chapter of the searched ebook as a relevant section to the section of selected chapter of the displayed ebook. These above steps are also repeated until each of the sections of the selected chapter of the displayed ebook has been selected and an associated section relevancy value has been computed.

The sort module 14 is for sorting the searched ebooks according to the relevancy values of the searched ebooks computed from the relevancy calculating module 13.

In the preferred embodiment, the sort module 14 sorts the searched ebooks whose abstract relevancy value is greater than the predetermined value in descending order, thereby obtaining an abstract relevancy search result of the displayed ebook. This abstract relevancy search result shows which ebooks are relevant to the displayed ebook.

The sort module 14 further sorts the relevant chapters of the searched ebooks in descending order, thereby obtaining a chapter relevancy search result of the selected chapter of the displayed ebook. This chapter relevancy search result shows which chapters of the relevant ebooks are relevant to the selected chapter of the displayed ebook.

The sort module also further sorts the relevant sections of the searched ebooks in descending order, thereby obtaining a section relevancy search result of the section of the selected chapter of the displayed ebook. This section relevancy search result distinctly shows which sections of the relevant ebooks are relevant to the selected section of the displayed ebook.

Therefore, based on the abstract relevancy search result, chapter relevancy search result, and section relevancy search result, relevant information of the displayed ebook can be easily and quickly obtained.

The record module 15 is for recording the relevancy values computed from the relevancy calculating module 13 and the relevacny search results from the sort module 14 in the storage unit 10. The display module 16 is for displaying relevant information of the displayed ebook according to the relevancy values and relevancy search results.

The ebook reading device provides an operational interface to input commands to search for relevant information of the displayed ebook. The operational interface may adopt a mechanical structure (namely where provides mechanical buttons or keys for operational inputs) or a software structure (namely a touch-based buttons or keys for operational inputs).

In the preferred embodiment, the ebook reading device provides a first button/key for inputting a command to view the abstract relevancy search result, a second button/key for inputting a command to view the chapter relevancy search result, and a third button/key for inputting a command to view the section relevancy search result.

In response to the command from the first button/key, the display module 16 displays relevant ebooks to the displayed ebook according to the abstract relevancy search result, thereby showing which ebooks can be viewed as references. In response to the command from the second or third button/key, the display module 16 displays detailed relevant ebooks according to the chapter or section relevancy search result, thereby to quickly and easily display desired information. Therefore, utilizing the search system, the reader can quickly and easily search relevant information as references when reading an ebook.

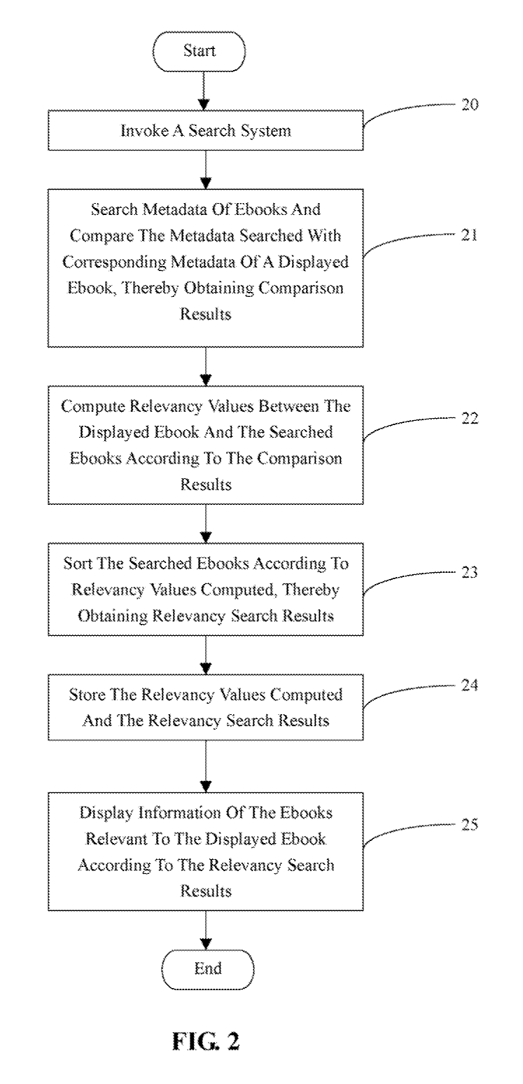

FIG. 2 is a flowchart of a preferred method for automatically searching for relevant ebooks by utilizing the search system of FIG. 1. In step S20, the search system is invoked. That is, the system start module 11 detects that the ebook reading device is in the ebook display state, that is, the work-rate of the processing unit of the ebook reading device reaches the predetermined value, thereupon the system start module 11 initiates the search module 12.

In step S21, the search module 12 searches through the metadata of each of the ebooks in the storage unit 10, and compares the searched metadata with the corresponding metadata of the displayed ebook, thereby obtaining comparison results (e.g., abstract keyword comparison results, chapter keyword comparison results, and section keyword comparison results).

In step S22, the relevancy calculating module 13 computes relevancy values between the displayed ebook and the searched ebooks according to the comparison results from the search module 12 and the associated weight values from the storage unit 10, thereby obtaining corresponding relevancy values (e.g., abstract relevancy values, chapter relevancy values, and section relevancy values).

In step S23, the sort module 14 sorts the searched ebooks according to the relevancy values from the relevancy calculating module 13, thereby obtaining corresponding relevancy search results for the displayed ebook (e.g., the abstract relevancy search result, the chapter relevancy search result, and the section relevancy search result).

In step S24, the record module 15 records the relevancy values from the relevancy calculating module 13 and the relevancy search results from the sort module 14 in the storage unit 10.

In step S25, the display module 16 displays relevant information of the displayed ebook according to the relevancy search results, if necessary.

For example, in response to the command from the first button/key of the operational interface of the ebook reading device (namely where the reader is desired to view the references of the displayed ebook), the display module 16 displays the relevant ebooks according to the abstract relevancy search result.

In response to the command from the second or third button/key of the operational interface of the ebook reading device (namely where the reader is desired to obtain detailed relevant information), the display module 16 displays corresponding relevant chapters or sections of the relevant ebooks according to the chapter or section relevancy search result.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A search system used in an ebook reading device, the system comprising:
a storage unit for storing metadata of ebooks and a weight table, wherein the weight table records each metadata and associated weight value;
a search module for searching metadata of the ebooks in the storage unit and comparing the metadata searched with corresponding metadata of an ebook currently displayed;
a relevancy calculating module for computing relevancy values between the ebook currently displayed and the searched ebooks according to comparison results provided by the search module and the weight values provided by the storage unit;
a sort module for sorting the searched ebooks according to relevancy values computed by the relevancy calculating module to generate corresponding relevancy search results; and
a record module for recording the relevancy values computed by the relevancy calculating module and the relevancy search results generated by the sort module.

2. The search system according to claim 1, further comprising a system start module for invoking the search module to perform search operations if the system start module detects the ebook reading device is in a predetermined state.

3. The search system according to claim 2, wherein the metadata of ebooks include a subject metadata, an abstract keyword metadata, a chapter keyword metadata, and a section keyword metadata.

4. The search system according to claim 3, wherein the comparison results include an abstract comparison result, a chapter comparison result, and a section comparison result.

5. The search system according to claim 4, wherein the relevancy search results include an abstract relevancy search result, a chapter relevancy search result, and a section relevancy search result.

6. The search system according to claim 5, further comprising a display module for displaying information of the ebooks relevant to the ebook currently displayed according to the relevancy search results.

7. A search method used in an ebook reading device, wherein the ebook reading device has a storage unit for storing metadata of ebooks and a weight table, the weight table recording each metadata and associated weight value, the method comprising the steps of:
searching metadata of the ebooks in the storage unit and comparing the metadata searched with corresponding metadata of an ebook currently displayed, thereby obtaining corresponding comparison results;
computing relevancy values between the ebook currently displayed and the searched ebooks according to the comparison results and the weight values, thereby obtaining corresponding relevancy values;
sorting the searched ebooks according to the relevancy values, thereby obtaining corresponding relevancy search results; and
recording the relevancy values computed and the relevancy search results.

8. The search method according to claim 7, further comprising the step of: invoking the searching step if detecting the ebook reading device is in a predetermined state.

9. The search method according to claim 7, further comprising the step of: displaying information of the ebooks relevant to the ebook currently displayed according to the relevancy search results.

10. The search method according to claim 9, wherein the metadata of ebooks include a subject metadata, an abstract keyword metadata, a chapter keyword metadata, and a section keyword metadata.

11. The search method according to claim 10, wherein the comparing step further comprises the steps of:
comparing the searched ebooks with the ebook currently displayed according to the subject metadata and abstract keyword metadata, thereby obtaining abstract comparison results;
comparing the searched ebooks with the ebook currently displayed according to the chapter keyword metadata, thereby obtaining chapter comparison results; and
comparing the searched ebooks with the ebook currently displayed according to the section keyword metadata, thereby obtaining section comparison results.

12. The search method according to claim 11, wherein the computing step further comprises the steps of:
computing relevancy values between the ebook currently displayed and the searched ebooks according to the abstract comparison results and the corresponding weight value, thereby obtaining abstract relevancy values;
computing relevancy values between the ebook currently displayed and the searched ebooks according to the chapter comparison results and the corresponding weight value, thereby obtaining chapter relevancy values; and
computing relevancy values between the ebook currently displayed and the searched ebooks according to the section comparison results and the corresponding weight value, thereby obtaining section relevancy values.

13. The search method according to claim 12, wherein the sorting step further comprises the steps of:
sorting the searched ebooks according to abstract relevancy values computed, thereby obtaining an abstract relevancy search result;
sorting the searched ebooks according to chapter relevancy values computed, thereby obtaining a chapter relevancy search result; and
sorting the searched ebooks according to section relevancy values computed, thereby obtaining a section relevancy search result.

14. The search method according to claim 13, wherein the displaying step further comprises the steps of:
displaying information of the ebooks relevant to the ebook currently displayed according to the abstract relevancy search result;
displaying information of the ebooks relevant to the ebook currently displayed according to the chapter relevancy search result; and displaying information of the ebooks relevant to the ebook currently displayed according to the section relevancy search result.
